(19) United States
(12) Patent Application Publication
(10) Pub. No.: US 2004/0148267 A1
(43) Pub. Date: Jul. 29, 2004

(54) Evaluation methodology and apparatus

(76) Inventor: George Henry Forman, Port Orchard, WA (US)

Correspondence Address: HEWLETT-PACKARD COMPANY, Intellectual Property Administration, P.O. Box 272400, Fort Collins, CO, 80527-2400, US

(21) Appl. No.: 10/354,845

(22) Filed: Jan. 29, 2003

(51) Int. Cl. G06F 15/18; G06F 17/00; G06N 5/02

(52) U.S. Cl. 706/46

(57) ABSTRACT

A method of evaluating multiple predetermined techniques, given a set of problems that the techniques are designed to be used on, the method comprising using each of the predetermined techniques on each of the problems and scoring the performance of each technique on each problem; recording, for each problem, the best obtainable score; and for a predetermined tolerance value, determining for each technique what percentage of the problems the technique scored within the tolerance value from the best obtainable score, and determining which technique has the highest percentage. An apparatus and computer program code are also provided.

### FIELD OF THE INVENTION

The disclosure relates to experiment evaluation. The disclosure also relates to data mining and robustness analysis.

### BACKGROUND OF THE INVENTION

Data mining and text classification techniques are known in the art. Data mining can involve classification of data into classes. Attention is directed to U.S. Pat. Nos. 6,182,058 to Kohavi and U.S. Pat. No. 6,278,464 to Kohavi et al., for example, that discuss classification systems and that are incorporated herein by reference.

Scientists and engineers often face the task of choosing one method from a number of competing methods by considering performance of the methods on a set of benchmark problems. For example, various feature selection methods exist in statistical learning of text categorization. These include, for example, Chi Squared, Information Gain (IG), Odds Ratio, Document Frequency, and others. These are described in an article by Yang, Y., Pedersen, J. O., “A Comparative Study on Feature Selection in Text Categorization,” International Conference on Machine Learning (ICML)(1997). Other methods may be used for other types of problems.

There are a great number of empirical studies that evaluate a set of competing methods by computing their average score by some objective function over a large number of test instances. For example, in information retrieval literature, various methods for feature selection or retrieval are evaluated by their micro-averaged or macro-averaged F-measure (the harmonic average of precision and recall) over a large number of categories. Similarly, machine learning studies often evaluate a set of techniques by their average accuracy or error rate achieved across a large number of problems.

In many situations, it is sufficient to select the method with the best average performance. However, sometimes averages can be misleading and may not adequately represent the end user's need. In many domains, no single method dominates over all others for all problems. Although one method may have a higher average than the others for the class of problems tested, it may be that another method would be superior for a specific dataset in question. It is also possible that a user may want a robust method that is most likely to deliver good performance for a single problem at hand, rather than the method that gives the best performance when averaged over many problems.

Statistical significance testing is known in the art. However, knowing that one method has statistically significantly better averages does not address the question of how often it fails to attain good performance, nor the residual. The nearest related work is in voting theory. For example, the Borda Count method combines the scores of a number of judges (benchmark problems) for a list of candidates (methods). Such methods determine a ranking of the candidates, but do not yield additional insight into the behavior and robustness of the candidates. Nor do they consider pairs of candidates.

### BRIEF DESCRIPTION OF THE VIEWS OF THE DRAWINGS

Embodiments of the invention are described below with reference to the following accompanying drawings.

FIG. 1 is a bar graph showing experimental results of average accuracy for various feature selection methods.

FIG. 2 is a graph of percentage of successes (best accuracy within tolerance) versus tolerance for various feature selection methods.

FIG. 3 is a graph of percentage of successes (best precision within tolerance) versus tolerance for various feature selection methods.

FIG. 4 is a graph that illustrates a method in accordance with embodiments of the invention.

FIG. 5 is flowchart illustrating logic in accordance with embodiments of the invention.

FIG. 6 is a block diagram of a computer system in accordance with embodiments of the invention.

### DETAILED DESCRIPTION

Attention is directed to U.S. patent application Ser. No. 10/253,041, (Attorney Docket Number 100204688-1), titled “Feature Selection For Two-Class Classification Systems,” naming as inventor George H. Forman, assigned to the assignee of the present application, and incorporated herein by reference.

In a study by the inventor, a suite of 229 benchmark problems was used to test the performance of a dozen techniques or methods. The methods were for feature selection in data mining, but the specific details of the methods, and purposes of the methods, are not necessary for the following discussion. Certain embodiments that will be described below are not necessarily limited to methods specific to feature selection, data mining, or to any other specific field.

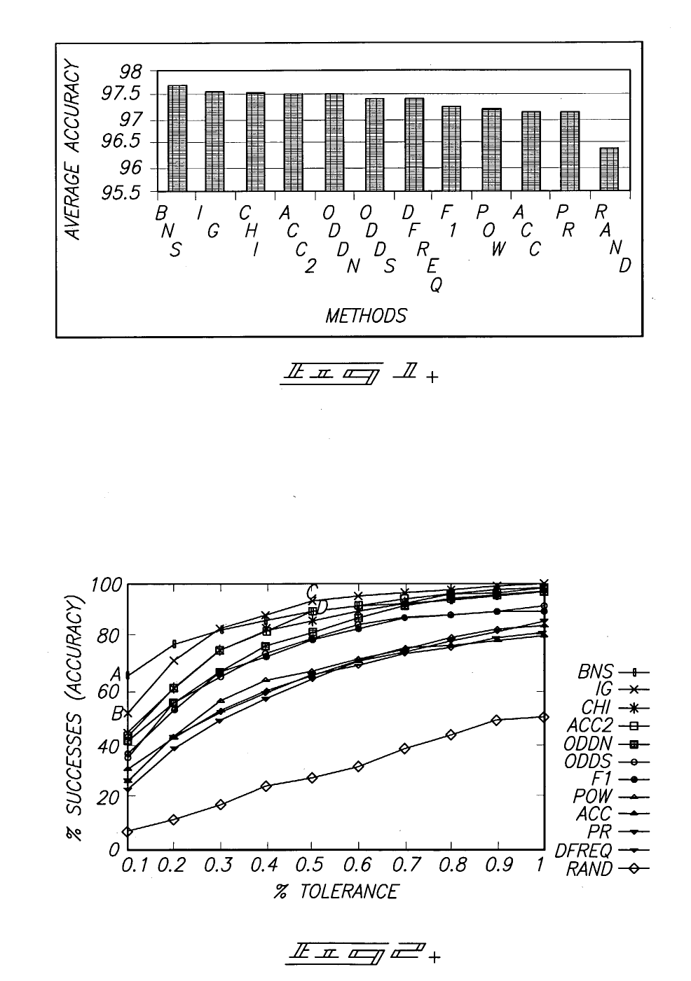

FIG. 1 shows accuracy averaged over the 229 problems, for each method. From this view, the Bi-Normal Separation (BNS) method is the clear winner. The difference was statistically significant—significance may not be the issue here. There may be more to consider, however. It might be that the runner-up method performed best on all problems but one, for which BNS achieved an exceptionally high score that brought its average way up.

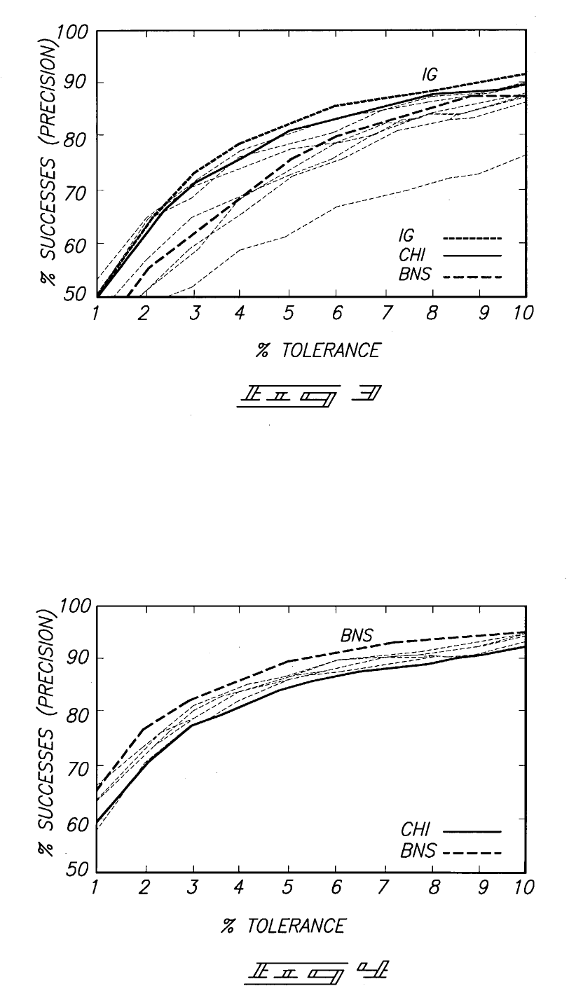

The inventor, therefore, developed a robustness analysis, called a “win analysis,” to provide additional insight. This comprises, in some embodiments, determining for what percentage of the benchmark problems each method achieved the best score—or nearly the best score within a tolerance ε (e.g, a percentage) of the best. For each of the benchmark problems, in one embodiment, the best score achieved by any method is determined, which varied widely from problem to problem. Then, for a given ε% tolerance parameter, a determination is made for each method, how often it attained within ε% of the best scores for the problems. FIG. 2 shows the results for this study, as tolerance is varied from 0.1% to 1%.

More may be learned from this view (FIG. 2) than from the simple average. For a tolerance of 0.1%, BNS attained the best performance on 65% of the problems, labeled point A, while the runner up, IG, attained within this tolerance on just 50% of the problems, labeled point B. This validates that BNS is not only best on average for these problems, but also best on most problems (at this tolerance). One may wonder whether BNS performed poorly on the remaining 35% of the problems. This would appear as a plateau in the curve, showing no improvement as the tolerance is increased. However, it did not; its curve continues to climb.

Suppose, however, that users desire robust methods more than they desire to obtain the best possible performance. If they would be satisfied to attain within 0.5% tolerance of the best possible score, IG attained best (or near best) performance on 93% of these particular problems, labeled point C, and BNS attained best performance on 90% of the problems, labeled point D. While both methods are competitive, IG is more reliable, assuming this tolerance level is acceptable.

Sometimes, it is desirable to select two best methods for deployment in a product, e.g., so that users have a second option to try if the first fails to obtain good performance on their problem. The programmer may select the second highest scoring method; however, it may fail to attain good performance on exactly those problems where the leading method fails. In fact, the inventor ran across this in his study. In FIG. 3, the results are shown for an analysis that is the same as the one shown in FIG. 2, but performed for a different goal (precision). The top performing method is IG at any tolerance level, and a good choice for second best method appears to be Chi Squared.

To consider this more deeply, further analysis in accordance with various embodiments of the invention is performed. This involves repeating the analysis procedure above, but only for those problems where the leading method failed to attain the best score.

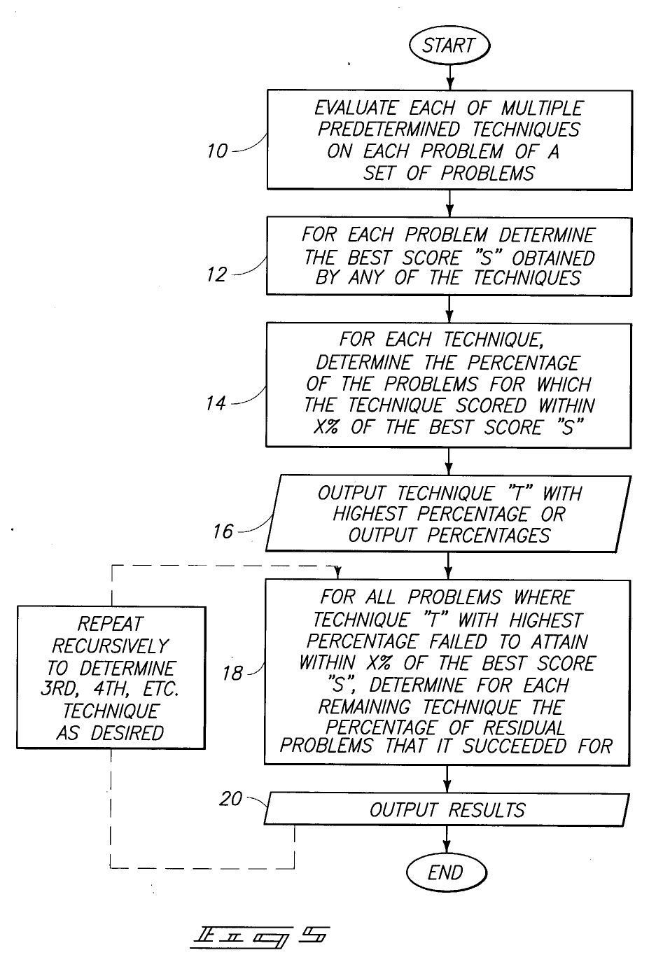

This leads to a surprising picture in FIG. 4. The y-axis is calibrated for comparison with the left-hand figure—it represents the percentage of problems for which IG or another selected method attained the best performance within the tolerance level; so, all of the curves in FIG. 4 lie above the IG curve of the FIG. 3 graph.

Chi Squared fails on most of the same problems where IG failed. Observe that its curve is among the worst combinations, performing little better than IG alone. In contrast, BNS succeeded most often on these residual cases, despite its lackluster performance in FIG. 3. In fact, by testing all pairs of metrics, the inventor found that the pair of methods BNS+Odds together yielded an even greater curve than BNS+IG paired together.

Embodiments of the invention provide a computer system 100 for performing the analysis described above or for performing the following steps. Other aspects provide computer program code, embodied in a computer readable media, for performing the analysis described above or for performing the following. Other embodiments provide computer program code embodied in a carrier wave for performing the analysis described above or for performing the following.

In step 10, the performance of each of N methods or techniques is evaluated on each problem of a set of problems (e.g., problems that are representative of natural problems one may encounter in practice or benchmark problems).

In step 12, the best score Sp obtained by any technique is determined for each problem p.

In step 14, for a single given tolerance value X (say 1%), a determination is made for each technique as to what percentage of the P problems the technique scored within tolerance (e.g., X %) of the best score Sp.

In step 16, at least the technique T with the highest percentage is reported or outputted. In one embodiment, all these percentages are reported or outputted. The technique T with the highest percentage most frequently yielded the best performance.

In step 18, for all problems where the technique T with the highest percentage failed to attain within X % of the best score Sp, determine for each remaining technique the percentage of the residual problems that it succeeded for (i.e., attained within X % of the score). The one with the highest percentage is a good second best or alternative technique that a practitioner (e.g., a data mining practitioner) should consider using along side technique T. Step 18 can be repeated to determine the 3^{rd}, 4^{th}, etc., techniques to be used together. Step 18 is substantially similar to the residual win analysis described above but described slightly differently.

In step 20, the computer system 100 or program code outputs or otherwise recommends to a user which set of techniques to try in order to obtain the best chance of getting nearly the best performance obtainable with any of the techniques (supposing their problem instance is drawn from a similar distribution of problems to that tested in the study). In some embodiments, the N methods are data mining methods. In other embodiments, the methods are feature selection methods for text classification. The recommended best, second best, third best, etc., methods can then be used on a problem other than the benchmark problems, e.g., using the computer system or program code.

In alternative embodiments, instead of choosing a fixed percentage tolerance, X may be varied from 0.1 to 10% to check the sensitivity of the answer. Repeat steps 14-20 for each tolerance. It may be that if one is willing to accept within a large tolerance (e.g., 5%) of the best score S, there may be a single technique that covers almost all problem instances.

In alternative embodiments, the “best” score for a problem may be the smallest score (rather than the largest score; as used in this example; e.g., in FIG. 1). For example, in the well known traveling salesman problem, the best solution is the one with minimum mileage.

In alternative embodiments, for step 12, the best score Sp for a given problem may be known by other means than by the best score observed by the competing techniques.

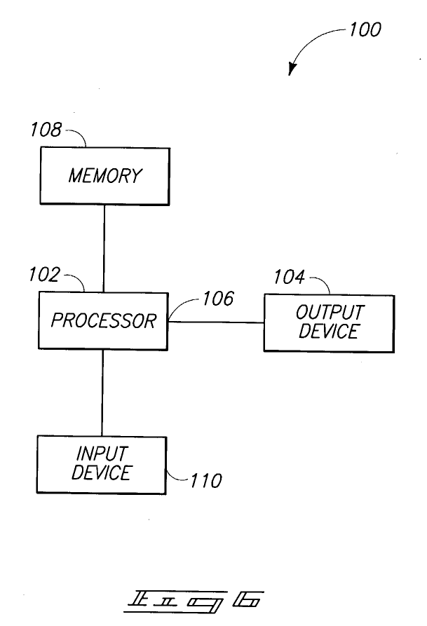

FIG. 6 shows a system 100 for performing the analysis described above. The system 100 includes a processor 102, an output device 104 coupled to the processor 102 via an output port 106, a memory or storage 108 embodying computer program code for carrying out the logic described above and in connection with FIG. 5, an input device 110 for inputting (or retrieving from memory) benchmark problems or new problems, and conventional components as desired. The memory 108 comprises, in various embodiments, random access memory, read only memory, a floppy disk, a hard drive, a digital or analog tape, an optical device, a memory stick or card, or any other type of memory used with computers or digital electronic equipment. Instead of operating on computer program code, digital or analog hard wired logic is used instead, in alternative embodiments.

While embodiments of the invention have been described above, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A method of evaluating multiple predetermined techniques, given a set of problems that the techniques are designed to be used on, the method comprising:
using each of the predetermined techniques on each of the problems and scoring the performance of each technique on each problem;
recording, for each problem, the best obtainable score; and
for a predetermined tolerance value, determining for each technique what percentage of the problems the technique scored within the tolerance value from the best obtainable score, and determining which technique has the highest percentage.

2. A method in accordance with claim 1 wherein determining the best obtainable score comprises determining the best obtainable score obtained by a technique selected from the group of techniques consisting of Bi-Normal Separation, Information Gain, and Chi Squared.

3. A method in accordance with claim 1 and further comprising, for problems where the technique that had the highest percentage did not score within the tolerance value of the best score, determining the percentage of these problems for which other techniques scored within the tolerance value.

4. A method in accordance with claim 3 and further comprising reporting the technique that had the highest percentage for the determining of the percentage of problems for which other techniques scored within the tolerance value.

5. A method in accordance with claim 1 and comprising determining for respective pairs of techniques the percentage of the problems for which the pair scored within the tolerance value from the best obtainable score.

6. A method in accordance with claim 1 and comprising determining for combinations of techniques the percentage of the problems for which the combination of techniques scored within the tolerance value from the best obtainable score.

7. A method in accordance with claim 1 and comprising varying the tolerance value.

8. A method in accordance with claim 7 and comprising reporting all of the percentages.

9. A method in accordance with claim 1 wherein recording, for each problem, the best obtainable score comprises inputting the best obtainable score.

10. A method in accordance with claim 1 wherein recording, for each problem, the best obtainable score comprises determining the best obtainable score using the predetermined techniques.

11. A method in accordance with claim 1 wherein the predetermined techniques are data mining techniques.

12. A method in accordance with claim 1 and further comprising using the technique that had the highest percentage on a problem other than the predetermined problems.

13. A memory embodying computer program code to evaluate multiple predetermined techniques, given a set of problems of types that the techniques are designed to be used on, the computer program code when executed by a processor, causing the processor to:
use each of the predetermined techniques on each of the problems and scoring the performance of each technique on each problem;
record, for each problem, the best obtainable score; and
for a predetermined tolerance value, determine for each technique what percentage of the problems the technique scored within the tolerance value from the best obtainable score, and determine which technique has the highest percentage.

14. A memory in accordance with claim 13 wherein determining the best obtainable score comprises determining the best obtainable score obtained by a technique selected from the group of techniques consisting of Bi-Normal Separation, Information Gain, and Chi Squared.

15. A memory in accordance with claim 13 wherein the code is further configured to, for problems where the technique that had the highest percentage did not score within the tolerance value of the best score, determine and report the percentage of these problems for which other techniques scored within the tolerance value.

16. A memory in accordance with claim 13 wherein the code is further configured to determine for each pair of techniques the percentage of the problems for which the pair of techniques scores within the tolerance value from the best obtainable score.

17. A memory in accordance with claim 13 wherein the code is further configured to determine for combinations of techniques the percentage of the problems for which the combination of techniques scored within the tolerance value from the best obtainable score.

18. A system for evaluating multiple predetermined techniques, given a set of problems of types that the techniques are designed to be used on, the system including a processor configured to:
use each of the available techniques on each of the problems and score the performance of each technique on each problem;
record, for each problem, the best obtainable score;
for a predetermined tolerance value, determine for each technique what percentage of the problems the technique scored with the tolerance value from the best obtainable score, and determine which technique had the highest percentage; and
for problems where the technique that had the highest percentage did not score within the tolerance value of the best score, determine the percentage of these problems for which other techniques scored within the tolerance value.

19. A system in accordance with claim 18 wherein the processor is further configured to report the technique that had the highest percentage for the second mentioned determination.

20. A system in accordance with claim 18 wherein the processor is configured to vary the tolerance value and to output the percentages for different tolerance values.

21. A system in accordance with claim 18 wherein the processor is configured to input the best obtainable score for each problem.

22. A system in accordance with claim 18 wherein the processor is configured to determine the best obtainable score using the predetermined techniques.

23. A system in accordance with claim 18 wherein the predetermined techniques are techniques for feature selection.

24. A system in accordance with claim 18 wherein the processor is further configured to use the technique that had the highest percentage on a problem other than the predetermined problems.

25. A system in accordance with claim 18 wherein the processor is further configured to use the technique that had the highest percentage on a data mining problem.

26. A system for evaluating multiple predetermined techniques, given a set of problems of types that the techniques are designed to be used on, the system comprising:
a processor;
an output coupled to the processor; and
a memory coupled to the processor and bearing computer program code which, when executed by the processor, causes the processor to:
use each of the available techniques on each of the problems and score the performance of each technique on each problem;
store, for each problem, the best obtainable score obtained by any of the techniques;
for a predetermined tolerance value, determine for each technique what percentage of the problems the technique scored with the tolerance value from the best obtainable score, and identify, at the output, which technique had the highest percentage; and
for residual problems where the technique that had the highest percentage did not score within the tolerance value of the best score, determine the percentage of these problems for which other techniques scored within the tolerance value and identify, at the output, which of these other techniques scored the highest percentage for the residual problems.

27. A system in accordance with claim 26 wherein for problems where the technique that had the highest percentage did not score within the tolerance value of the best score, the processor being configured to identify, at the output, the percentage of these problems for which the other techniques scored within the tolerance value.

28. A system for evaluating multiple predetermined techniques, the system comprising:
means for inputting a set of problems of types that the techniques are designed to be used on;
means for using each of the available techniques on each of the problems;
means for scoring the performance of each technique on each problem;
first means for determining, for each problem, the best score obtainable using any of the techniques;
for a predetermined tolerance value, second means for determining for each technique what percentage of the problems the technique scored with the tolerance value from the best score, and determining which technique had the highest percentage; and
for problems where the technique that had the highest percentage did not score within the tolerance value of the best score, third means for determining the percentage of these problems for which other techniques scored within the tolerance value.

29. A system in accordance with claim 28 and further comprising means for outputting the technique that had the highest percentage from the second determining means.

30. A system in accordance with claim 28 and further comprising means for outputting the technique that had the highest percentage from the third determining means.
